(19) United States
(12) Patent Application Publication
(10) Pub. No.: US 2026/0313730 A1
(43) Pub. Date: Oct. 8, 2026

(54) SLEEP-CYCLE NEGOTIATION METHOD, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/482,582

(22) PCT Filed: May 9, 2023
(86) PCT No.: PCT/CN2023/093066

§ 371 Date: Nov. 7, 2025

(51) Int. Cl. H04W 76/15; H04W 52/02

(52) U.S. Cl. CPC H04W 76/15; H04W 52/0216

(57) ABSTRACT

The present disclosure provides a sleep-cycle negotiation method. The sleep-cycle negotiation method is performed by a first AP. The method includes: determining a first frame, wherein the first radio frame includes a first information element, and the first information element includes sleep-cycle information of a first AP for a first link and sleep cycle information of a second AP for a second link; and sending the first frame.

### CROSS REFERENCE TO RELATED APPLICATIONS

The present disclosure is the U.S. national phase application of International Application No. PCT/CN2023/093066 filed on May 9, 2023, the content of which is incorporated herein by reference in its entirety for all purposes.

### TECHNICAL FIELD

The present disclosure relates to the field of mobile communication technology, in particular, to a sleep-cycle negotiation method, an electronic device, and a storage medium.

### BACKGROUND

The present researching topic on Wi-Fi technology includes, for example, Ultra High Reliability (UHR), a vision of which is to improve the reliability of Wireless Local Area Network (WLAN) connectivity, reduce latency, enhance manageability, increasing throughput at different Signal to Noise Ratio (SNR) levels, and reduce device level power consumption. In UHR, the power-saving mechanism will be further enhanced.

### SUMMARY

In one aspect of embodiments of the present disclosure, a sleep-cycle negotiation method is provided. The method is performed by a first access point (AP), and includes: determining a first frame, wherein the first frame includes a first information element, the first information element includes sleep-cycle information of the first AP for a first link and sleep-cycle information of a second AP for a second link, and the first AP and the second AP are affiliated to a same access point multi-link device (AP MLD); and sending the first frame.

In another aspect of embodiments of the present disclosure, a sleep-cycle negotiation method is also provided. The method is performed by a station (STA), and includes: receiving a first frame, wherein the first frame includes a first information element, the first information element includes sleep-cycle information of a first access point (AP) for a first link and sleep-cycle information of a second AP for a second link; and the first AP and the second AP are affiliated to a same access point multi-link device (AP MLD).

Embodiments of the present disclosure also provide an electronic device including a memory, a processor, and a computer program stored on the memory and executable by the processor, wherein the processor is configured to execute the computer program to implement the methods described in one or more embodiments of the present disclosure.

Embodiments of the present disclosure also provide a computer-readable storage medium having a computer program stored thereon, which when executed by a processor, causes the methods described in one or more embodiments of the present disclosure to be implemented.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a schematic diagram of an application scenario according to embodiments of the present disclosure;

FIG. 2 is a first flowchart of a sleep-cycle negotiation method according to embodiments of the present disclosure;

FIG. 3 is a second flowchart of a sleep-cycle negotiation method according to embodiments of the present disclosure;

FIG. 4 is a first schematic diagram of a structure of an electronic device according to embodiments of the present disclosure;

FIG. 5 is a second schematic diagram of a structure of an electronic device according to embodiments of the present disclosure; and

FIG. 6 is a third schematic diagram of a structure of an electronic device according to embodiments of the present disclosure.

### DETAILED DESCRIPTION

A detailed explanation of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of the present disclosure as detailed in the appended claims.

The terms used in embodiments of the present disclosure are for the purpose of description of specific embodiments only, and are not intended to limit the embodiments of the present disclosure. Singular forms such as “a”, “said”, and “the” used in embodiments of the present disclosure and the appended claims are also intended to include plural forms, unless other meanings are clearly indicated in the context. It should also be understood that the term “and/or” used in the present disclosure refers to and includes any or all possible combinations of one or more listed items related. For example, A and/or B can indicate the presence of A alone, the presence of A and B simultaneously, and the presence of B alone. The character “/” generally indicates that associated objects have an “or” relationship between them. The term “multiple” refers to two or more, and therefore, in embodiments of the present disclosure, “multiple” can also be understood as “at least two”.

It should be understood that although terms such as first, second, and third may be used to describe various information in embodiments of the present disclosure, such information should not be limited to these terms, which are only used to distinguish information about the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

A clear and complete description of technical solutions disclosed in the embodiments of the present disclosure will be provided in the following, in conjunction with the drawings. Obviously, the embodiments described are only a part of disclosed embodiments of the present disclosure and not all of them. Based on the embodiments of the present disclosure, all other embodiments obtained by those of ordinary skill in the art without creative efforts fall within the protection scope of the present disclosure.

Embodiments of the present disclosure provide a sleep-cycle negotiation method, an electronic device, and a storage medium, to provide a mechanism that supports the AP's power-saving.

In some embodiments, the method and the device are based on the same application concept. Due to the similar principles for solving problems used by the method and the device, the implementations of the device and the method can be referred to each other, which will not be repeated.

As shown in FIG. 1, which illustrates one of schematic diagrams of an application scenario where a method for low latency traffic transmission is provided according to various embodiments of the present disclosure. In some embodiments, a station (STA) such as an electronic device with a wireless network access capability provides frame delivery services to facilitate the transmission of information. An access point (AP) such as a device with a wireless to wired bridging capability is responsible for extending the services provided by a wired network to a wireless network.

In FIG. 1, a first AP (AP1) and a second AP (AP2) are affiliated to the same access point multi-link device (AP MLD). In general, the AP can have three forms, such as a soft AP (or a soft AP MLD), a Non-Simultaneous Transmitting and Receiving (NSTR) mobile AP (or an NSTR mobile AP MLD), and a regular AP (or a regular AP MLD). The regular AP includes such as a router. The soft AP and the NSTR mobile AP are taken as examples, they are usually powered by batteries, with high power consumption, and their communication with STAs is usually not in a long-term continuous state. Therefore, it is necessary to provide a mechanism that supports the AP's power-saving.

In embodiments of the present disclosure, as shown in FIG. 1, the AP1 executes a step 101 to determine and send a first frame. The first frame includes a first information element, and the first information element includes sleep-cycle information of a first AP for a first link (Link1) and sleep-cycle information of a second AP for a second link (Link2). That is, the AP1 negotiates sleep cycles for multiple links over one link to save signaling. For example, if the AP corresponding to each link negotiates the sleep-cycle information with the STA separately over a respective link therebetween, it will occupy a large amount of signaling messages for negotiating sleep cycles, resulting in a waste of network transmission resources.

In some embodiments, the first frame is, for example, a Beacon frame, a Probe Response frame, an Association Response frame, or a Reassociation Response frame. In some embodiments, the Probe Response frame can be an unsolicited Probe Response frame. The first information element includes first identification information and time parameter information.

In some embodiments, the first identification information is configured to indicate a link corresponding to each sleep-cycle information. For example, the first identification information is configured to indicate the link through a link identifier (ID) or through a link bitmap. For example, if a link bitmap identifier is set to 1, the sleep-cycle information of the AP corresponding to that link is indicated.

The time parameter information includes a time parameter of a sleep cycle for a corresponding link, and the time parameter includes at least two of the following: a starting time of the sleep cycle for the corresponding link, an ending time of the sleep cycle for the corresponding link, and a duration of the sleep cycle for the corresponding link.

In some embodiments, the time parameter is determined based on a reference time and a time offset value for the corresponding link. That is, an absolute time of the sleep cycle is determined based on the reference time and the time offset value. The reference time includes a time of sending the first frame, for example, the time of AP1 broadcasting the first frame.

In some embodiments, as shown in FIG. 1, the first information element can include two formats, namely Format 1 and Format 2.

In Format 1, the first identification information includes first link control information (Link control) and link identifier information (Link identifier). In some embodiments, the first link control information indicates quantity information of the sleep-cycle information in the first information element, that is, the first link control information indicates the number of sleep cycles included in the first information element, for example, each sleep-cycle information corresponds to a link. The link identifier information indicates the corresponding link for each sleep-cycle information.

In Format 2, the first identification information includes link presence information, and the link presence information indicates whether sleep-cycle information for a corresponding link is included in the first information element. The link presence information includes, for example, a link bitmap. If a link bitmap identifier is set to 1, the sleep-cycle information of the AP corresponding to that link is indicated.

In addition, in Format 2, in some embodiments, the first identification information includes second link control information (Link control), and the second link control information indicates quantity information of the sleep cycle(s) included in the first information element. That is, the second link control information indicates the number of sleep cycles included in the first information element.

In embodiments of the present disclosure, the sleep time indicated by the sleep-cycle information does not overlap with a Target Wake Time (TWT) Service Period (SP) for the link corresponding to the sleep-cycle information. For the negotiation of the sleep cycle, the AP can negotiate the sleep cycle based on the TWT SP(s) of its link(s), and the sleep time does not overlap with the TWT SP(s), ensuring that the AP can serve the associated STA(s) working over the link(s) as much as possible. Alternatively, the AP can negotiate the TWT SP based on the sleep cycle of the AP.

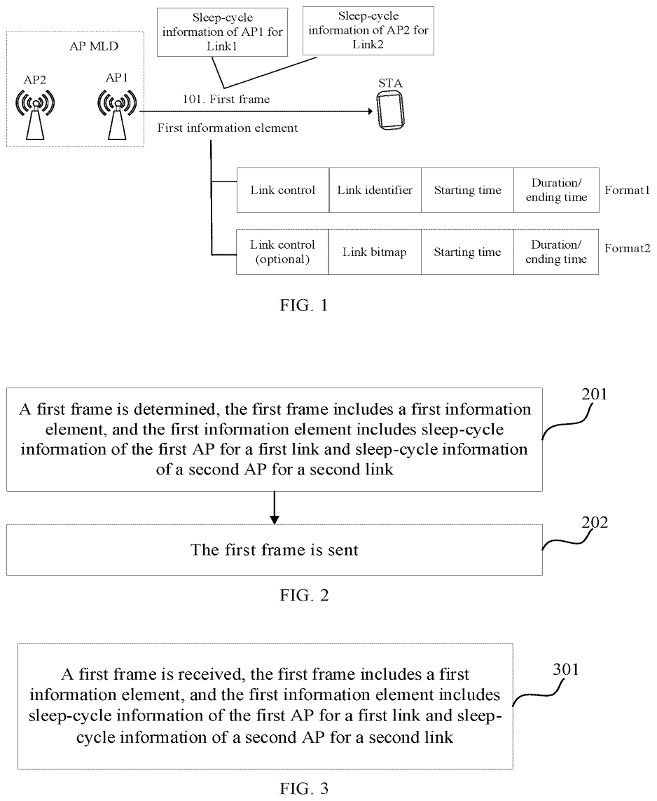

As shown in FIG. 2, embodiments of the present disclosure provide a sleep-cycle negotiation method. The method can be performed by a first access point (AP), and the method can include the following steps.

In step 201, a first frame is determined, the first frame includes a first information element, and the first information element includes sleep-cycle information of the first AP for a first link and sleep-cycle information of a second AP for a second link.

In step 202, the first frame is sent.

The first AP determines and sends the first frame. In some embodiments, the first frame includes a first information element, and the first information element includes sleep-cycle information of the first AP for the first link (Link1) and sleep-cycle information of the second AP for the second link (Link2). That is, the AP1 negotiates sleep cycles for multiple links over one link to save signaling. For example, if the AP corresponding to each link negotiates the sleep-cycle information with the STA separately over a respective link therebetween, it will occupy a large amount of signaling messages for negotiating sleep cycles, resulting in a waste of network transmission resources.

In some embodiments, the first frame includes a Beacon frame, a Probe Response frame, an Association Response frame, or a Reassociation Response frame. In some embodiments, the Probe Response frame can be an unsolicited Probe Response frame.

In some embodiments, the first information element includes first identification information and time parameter information.

The first identification information indicates a link corresponding to each sleep-cycle information.

The time parameter information includes a time parameter of a sleep cycle for a corresponding link, the time parameter is determined based on a reference time and a time offset value for the corresponding link, and the reference time includes a time of sending the first frame. The first identification information is configured to indicate the link corresponding to each sleep-cycle information. For example, the first identification information is configured to indicate the link through a Link ID or through a Link bitmap. For example, if a link bitmap identifier is set to 1, the sleep-cycle information of the AP corresponding to that link is indicated.

In some embodiments of the present disclosure, the time parameter includes at least two of the following: a starting time of the sleep cycle for the corresponding link, an ending time of the sleep cycle for the corresponding link, and a duration of the sleep cycle for the corresponding link.

In some embodiments, each time parameter can be determined based on the reference time and the time offset value for the corresponding link. That is, an absolute time of the sleep cycle is determined based on the reference time and the time offset value. The reference time includes a time of sending the first frame, for example, the time of AP1 broadcasting the first frame.

In some embodiments of the present disclosure, the first identification information includes first link control information and link identifier information.

The first link control information indicates quantity information of the sleep-cycle information in the first information element, and the link identifier information indicates the corresponding link for each sleep-cycle information.

As shown in Table 1, the first identification information includes first link control information (Link control) and link identifier information (Link identifier). In some embodiments, the first link control information indicates quantity information of the sleep-cycle information in the first information element, that is, the first link control information indicates the number of sleep cycles included in the first information element. For example, if each sleep-cycle information corresponds to a link, then the link identifier information indicates the corresponding link for each sleep-cycle information.

TABLE 1

| | | | |
|---|---|---|---|
| Link control (first | Link identifier (link | Starting time | Duration/ |
| link control | identifier information) | | Ending time |
| information) | | | |

In some embodiments, Table 1 shows the first format of the first information element. In addition to the first identification information, the first information element also includes the time parameter information, such as the starting time, the ending time, and the duration of the sleep cycle for the corresponding link.

In some embodiments, as shown in Table 2, the first identification information includes link presence information, and the link presence information indicates whether the sleep-cycle information for a corresponding link is included in the first information element. The link presence information includes, for example, a link bitmap. If a link bitmap identifier is set to 1, the sleep-cycle information of the AP corresponding to that link is indicated.

TABLE 2

| | | | |
|---|---|---|---|
| Link control | Link bitmap (link | Starting time | Duration/ |
| (optional) | presence information) | | Ending time |

In some embodiments, Table 2 shows the second format of the first information element. In addition to the first identification information, the first information element also includes the time parameter information, such as the starting time, the ending time, and the duration of the sleep cycle for the corresponding link.

In embodiments of the present disclosure, the first identification information includes second link control information, and the second link control information indicates quantity information of the sleep cycle(s) included in the first information element. In Table 2, optionally, the first identification information includes second link control information (Link control) that indicates quantity information of the sleep cycle(s) included in the first information element. That is, the second link control information indicates the number of sleep cycles included in the first information element.

In embodiments of the present disclosure, the sleep time indicated by the sleep-cycle information does not overlap with a TWT SP for the link corresponding to the sleep-cycle information. For the negotiation of the sleep cycle, the AP can negotiate the sleep cycle based on the TWT SP(s) of its link(s), and the sleep time does not overlap with the TWT SP(s), ensuring that the AP can serve the associated STA(s) working over the link(s) as much as possible. Alternatively, the AP can negotiate the TWT SP based on the sleep cycle of the AP.

In embodiments of the present disclosure, the AP determines and sends the first frame. The first frame includes the first information element, which includes sleep-cycle information of the first AP for the first link and sleep-cycle information of the second AP for the second link. In this way, the AP can negotiate sleep cycles for multiple links over one link, so as to save the signaling, and to avoid negotiating the sleep-cycle information for many times, which may occupy a large amount of signaling messages, and cause a waste of network transmission resources. Embodiments of the present disclosure provide a mechanism that supports the AP's power-saving.

As shown in FIG. 3, embodiments of the present disclosure provide a sleep-cycle negotiation method. The method can be performed by a station (STA), and the method can include the following steps.

In step 301, a first frame is received, the first frame includes a first information element, and the first information element includes sleep-cycle information of a first AP for a first link and sleep-cycle information of a second AP for a second link.

The first AP and the second AP are affiliated to the same access point multi-link device (AP MLD).

The STA receives the first frame, obtains and parses the first information element included in the first frame. In some embodiments, the first information element includes sleep-cycle information of the first AP for the first link (Link1) and sleep-cycle information of the second AP for the second link (Link2). That is, the AP1 negotiates sleep cycles for multiple links over one link to save signaling. For example, if the AP corresponding to each link negotiates the sleep-cycle information with the STA separately over a respective link therebetween, it will occupy a large amount of signaling messages for negotiating sleep cycles, resulting in a waste of network transmission resources.

In some embodiments, the first frame includes a Beacon frame, a Probe Response frame, an Association Response frame, or a Reassociation Response frame. In some embodiments, the Probe Response frame can be an unsolicited Probe Response frame.

In some embodiments, the first information element includes first identification information and time parameter information.

The first identification information indicates a link corresponding to each sleep-cycle information.

The time parameter information includes a time parameter of a sleep cycle for a corresponding link, the time parameter is determined based on a reference time and a time offset value for the corresponding link, and the reference time includes a time of sending the first frame.

The time parameter information includes a time parameter of a sleep cycle for a corresponding link, the time parameter is determined based on a reference time and a time offset value for the corresponding link, and the reference time includes a time of sending the first frame. The first identification information is configured to indicate the link corresponding to each sleep-cycle information. For example, the first identification information is configured to indicate the link through a Link ID or through a Link bitmap. For example, if a link bitmap identifier is set to 1, the sleep-cycle information of the AP corresponding to that link is indicated.

In some embodiments of the present disclosure, the time parameter includes at least two of the following: a starting time of the sleep cycle for the corresponding link, an ending time of the sleep cycle for the corresponding link, and a duration of the sleep cycle for the corresponding link.

In some embodiments, each time parameter can be determined based on the reference time and the time offset value for the corresponding link. That is, an absolute time of the sleep cycle is determined based on the reference time and the time offset value. The reference time includes a time of sending the first frame, for example, the time of AP1 broadcasting the first frame.

In some embodiments of the present disclosure, the first identification information includes first link control information and link identifier information.

The first link control information indicates quantity information of the sleep-cycle information in the first information element, and the link identifier information indicates the corresponding link for each sleep-cycle information. As shown in Table 1 below, the first identification information includes first link control information (Link control) and link identifier information (Link identifier). In some embodiments, the first link control information indicates quantity information of the sleep-cycle information in the first information element, that is, the first link control information indicates the number of sleep cycles included in the first information element. For example, if each sleep-cycle information corresponds to a link, then the link identifier information indicates the corresponding link for each sleep-cycle information.

TABLE 1

| | | | |
|---|---|---|---|
| Link control (first | Link identifier (link | Starting time | Duration/ |
| link control | identifier information) | | Ending time |
| information) | | | |

In some embodiments, Table 1 shows the first format of the first information element. In addition to the first identification information, the first information element also includes the time parameter information, such as the starting time, the ending time, and the duration of the sleep cycle for the corresponding link.

In some embodiments of the present disclosure, as shown in Table 2 below, the first identification information includes link presence information, and the link presence information indicates whether the sleep-cycle information for a corresponding link is included in the first information element. The link presence information includes, for example, a link bitmap. If a link bitmap identifier is set to 1, the sleep-cycle information of the AP corresponding to that link is indicated.

TABLE 2

| | | | |
|---|---|---|---|
| Link control | Link bitmap (link | Starting time | Duration/ |
| (optional) | presence information) | | Ending time |

In some embodiments, Table 2 shows the second format of the first information element. In addition to the first identification information, the first information element also includes the time parameter information, such as the starting time, the ending time, and the duration of the sleep cycle for the corresponding link.

In embodiments of the present disclosure, the first identification information includes second link control information, and the second link control information indicates quantity information of the sleep cycle(s) included in the first information element. In Table 2, optionally, the first identification information includes second link control information (Link control) that indicates quantity information of the sleep cycle(s) included in the first information element. That is, the second link control information indicates the number of sleep cycles included in the first information element.

In embodiments of the present disclosure, the sleep time indicated by the sleep-cycle information does not overlap with a TWT SP for the link corresponding to the sleep-cycle information. For the negotiation of the sleep cycle, the AP can negotiate the sleep cycle based on the TWT SP(s) of its link(s), and the sleep time does not overlap with the TWT SP(s), ensuring that the AP can serve the associated STA(s) working over the link(s) as much as possible. Alternatively, the AP can negotiate the TWT SP based on the sleep cycle of the AP.

In some embodiments of the present disclosure, the method further includes: at least two sleep-cycle information corresponding to the same link is received, and sleep-cycle information with the latest sending time is used as the sleep-cycle information for the link.

In some embodiments, the sleep-cycle information broadcasted by the AP over a certain link may change. For example, if the AP negotiates with the STA that its low latency traffic transmission slot overlaps with the sleep cycle, the AP may change its sleep cycle parameters. If such a change occurs, the AP may broadcast again. Therefore, the STA takes the sleep cycle of the AP included in the latest received first frame as the sleep-cycle information for the link.

In embodiments of the present disclosure, the STA receives the first frame and obtains the first information element included in the first frame, which includes sleep-cycle information of the first AP for the first link and sleep-cycle information of the second AP for the second link. In this way, sleep cycles for multiple links over one link can be negotiated over one link, so as to save the signaling, and to avoid negotiating the sleep-cycle information for many times, which may occupy a large amount of signaling messages, and cause a waste of network transmission resources. Embodiments of the present disclosure provide a mechanism that supports the AP's power-saving.

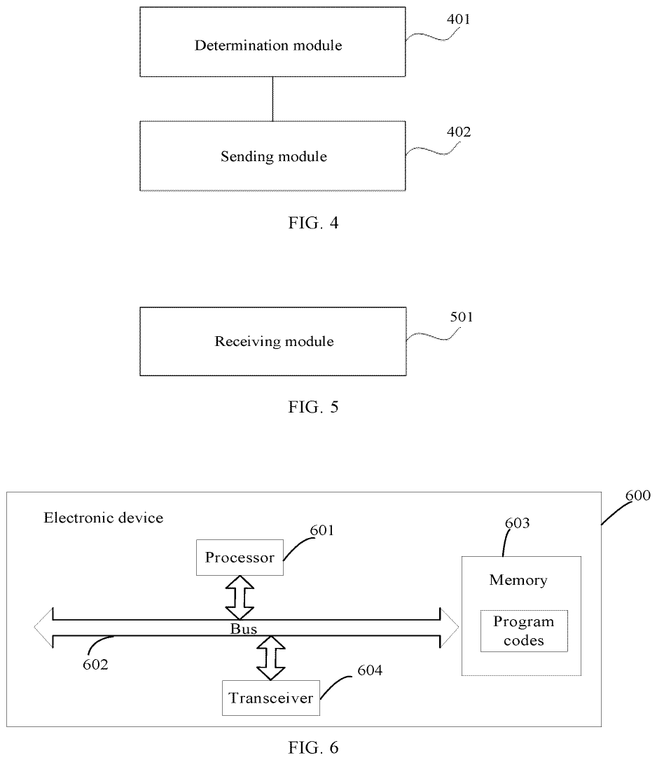

As shown in FIG. 4, based on the same principles as the methods provided in embodiments of the present disclosure, embodiments of the present disclosure also provide an electronic device, the electronic device is a first access point (AP), and the electronic device includes a determination module 401 and a sending module 402.

The determination module 401 is configured to determine a first frame, the first frame includes a first information element, and the first information element includes sleep-cycle information of the first AP for a first link and sleep-cycle information of a second AP for a second link.

The sending module 402 is configured to send the first frame.

Embodiments of the present disclosure also provide a sleep-cycle negotiation apparatus. The apparatus is applied to the first access point (AP), and the apparatus includes following modules.

A frame determination module configured to determine a first frame, the first frame includes a first information element, and the first information element includes sleep-cycle information of the first AP for a first link and sleep-cycle information of a second AP for a second link.

A frame sending module configured to send the first frame.

The apparatus also includes other modules of the electronic device in the previous embodiments, which will not be repeated here.

As shown in FIG. 5, based on the same principles as the methods provided in embodiments of the present disclosure, embodiments of the present disclosure also provide an electronic device, the electronic device is a station (STA), and the electronic device includes a receiving module 501.

The receiving module 501 is configured to receive a first frame, the first frame includes a first information element, and the first information element includes sleep-cycle information of a first AP for a first link and sleep-cycle information of a second AP for a second link.

The first AP and the second AP are affiliated to the same access point multi-link device (AP MLD).

Embodiments of the present disclosure also provide a sleep-cycle negotiation apparatus. The apparatus is applied to the station (STA), and the apparatus includes following modules.

A frame receiving module configured to receive a first frame, the first frame includes a first information element, and the first information element includes sleep-cycle information of a first AP for a first link and sleep-cycle information of a second AP for a second link.

The first AP and the second AP are affiliated to the same access point multi-link device (AP MLD).

The apparatus also includes other modules of the electronic device in the previous embodiments, which will not be repeated here.

In some embodiments, embodiments of the present disclosure also provide an electronic device, as shown in FIG. 6. The electronic device 600 shown in FIG. 6 can be a server, and includes a processor 601 and a memory 603. In some embodiments, the processor 601 is connected to the memory 603, for example, connected via a bus 602. In some embodiments, the electronic device 600 can further include a transceiver 604. It should be noted that in practical applications, the transceiver 604 is not limited to one transceiver, and the structure of the electronic device 600 does not constitute a limitation on embodiments of the present disclosure.

The processor 601 can be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various exemplary logical blocks, modules, and circuits described in conjunction with the present disclosure. The processor 601 can also be a combination of computing functions, such as a combination containing one or more microprocessors, a combination containing the DSP and the microprocessor, etc.

The bus 602 can include a path for delivering information between the aforementioned components. The bus 602 can be a PCI (Peripheral Component Interconnect) bus or an EISA (Extended Industry Standard Architecture) bus, etc. The bus 602 can be divided into an address bus, a data bus, a control bus, etc. For ease of representation, only one thick line is used in FIG. 6, but it does not mean that there is only one bus or one type of bus.

The memory 603 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory), or other optical disk storage devices, optical disc storage devices (including compressed discs, laser discs, optical discs, digital universal discs, Blu-ray discs, etc.), magnetic disk storage media or other magnetic storage devices, or any other media that can be used to carry or store desired program codes in the form of instructions or data structures and can be accessed by computers, but not limited to this.

The memory 603 is used to store application program codes for implementing the present disclosure, and the execution of the codes is controlled by the processor 601. The processor 601 is used to execute the application program codes stored in the memory 603 to implement the methods provided in the aforementioned method embodiments.

In some embodiments, the electronic device includes but is not limited to mobile phones, laptops, digital broadcasting receivers, PDAs (Personal Digital Assistant), PADs (tablet), PMPs (Portable Multimedia Player), in-vehicle terminals (such as in-vehicle navigation terminals), and fixed terminals such as digital TVs, desktop computers, and so on. The electronic device shown in FIG. 6 is only an example and should not impose any limitations on the functionality and the use scope of embodiments of the present disclosure.

The server provided in the present disclosure can be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, as well as big data and artificial intelligence platform. The terminal can be smartphone, tablet, laptop, desktop computer, smart speaker, smartwatch, etc., but is not limited to this. The terminal and the server can be directly or indirectly connected through wired or wireless communication methods, and the present disclosure is not limited here.

Embodiments of the present disclosure provide a non-transitory computer-readable storage medium on which a computer program is stored. When the computer program is running on a computer, enables the computer to implement the corresponding content of the aforementioned method embodiments.

It should be understood that although the various steps in the flowchart in the drawings are displayed in sequence indicated by arrows, these steps are not necessarily executed in the order indicated by the arrows. Unless explicitly stated in the article, the execution of these steps does not have strict order restrictions and can be included out in other orders. Moreover, at least a portion of the steps in the flowchart of the drawings can include multiple sub steps or stages, which may not necessarily be completed at the same time, but may be executed at different times, and their execution order may not necessarily be in sequence, but may rotate or alternate with at least a portion of other steps or sub steps or stages.

It should be noted that the non-transitory computer-readable medium mentioned in the present disclosure can be a computer-readable signal medium, a computer-readable storage medium, or any combination of the two. The computer-readable storage medium can be, but is not limited to, an electrical, magnetic, optical, electromagnetic, infrared, or semiconductor system, apparatus, or device, or any combination thereof. More specific examples of the computer-readable storage medium can include, but are not limited to: electrical links with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the present disclosure, a computer-readable storage medium can be any tangible medium containing or storing a program, which can be used by an instruction execution system, apparatus, or device, or in combination with it. In the present disclosure, the computer-readable signal medium can include data signals propagated in the baseband or as part of the carrier wave, which carry computer-readable program codes. This type of transmitted data signal can take various forms, including but not limited to electromagnetic signals, optical signals, or any suitable combination of the above. The computer-readable signal medium can also be any computer-readable medium other than a computer-readable storage medium, which can send, propagate, or transmit programs for use by an instruction execution system, apparatus, or device, or in combination with it. The program code contained on the computer-readable medium can be transmitted using any appropriate medium, including but not limited to: wires, optical cables, RF (radio frequency), etc., or any suitable combination of the above.

The above-mentioned computer-readable medium can be included in the electronic device mentioned above. It can also exist separately without being assembled into the electronic device.

The above-mentioned computer-readable medium carries one or more programs, which, when executed by the electronic device, cause the electronic device to implement the methods shown in the above embodiments.

According to one aspect of the present disclosure, a computer program product or a computer program is provided, including computer instructions stored in a computer-readable storage medium. The processor of a computer device reads the computer instructions from the computer-readable storage medium, executes the computer instructions, and causes the computer device to implement the methods provided in the various embodiments mentioned above.

The computer program codes for implementing the operations disclosed herein can be written in one or more programming languages or combinations thereof, including object-oriented programming languages such as Java, Smalltalk, C++, and conventional procedural programming languages such as C or similar programming languages. The program codes can be completely executed on the user's computer, partially executed on the user's computer, executed as an independent software package, partially executed on the user's computer and partially executed on a remote computer, or completely executed on the remote computer or a server. In the case where remote computers are involved, the remote computer can be connected to the user computer through any type of networks, including local area networks (LAN) or wide area networks (WAN), or can be connected to an external computer (such as connected via the internet provided by internet service providers).

The flowchart and the block diagram in the drawings illustrate the possible architectures, functions, and operations of the systems, methods, and computer program products according to various embodiments of the present disclosure. Each box in a flowchart or block diagram can represent a module, a program segment, or a part of codes that contain one or more executable instructions for implementing a specified logical function. It should also be noted that in some embodiments, the functions indicated in the box can also occur in a different order than those indicated in the drawings. For example, two consecutive boxes can actually be executed in basic parallel order, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in embodiments of the present disclosure can be implemented through software or hardware. In some embodiments, the name of the module does not constitute a limitation on the module itself in a certain situation. For example, module A can also be described as “module A used to perform operation B”.

The above description is only for embodiments of the present disclosure and an explanation of the technical principles involved. Those skilled in the art should understand that the scope of the present disclosure is not limited to technical solutions formed by specific combinations of the technical features mentioned above, and should also cover other technical solutions formed by arbitrary combinations of the technical features mentioned above or their equivalent features without departing from the concept disclosed. For example, a technical solution formed by replacing the above features with technical features with similar functions disclosed (but not limited to) in the present disclosure.

1. A sleep-cycle negotiation method, performed by a first access point (AP), the method comprising:
determining a first frame, wherein the first frame comprises a first information element, the first information element comprises sleep-cycle information of the first AP for a first link and sleep-cycle information of a second AP for a second link, and the first AP and the second AP are affiliated to a same access point multi-link device (AP MLD); and
sending the first frame.

2. The sleep-cycle negotiation method according to claim 1, wherein the first information element comprises first identification information and time parameter information;
the first identification information indicates a corresponding link for each sleep-cycle information;
the time parameter information comprises a time parameter of a sleep cycle for the corresponding link, the time parameter is determined based on a reference time and a time offset value for the corresponding link, and the reference time comprises a time of sending the first frame.

3. The sleep-cycle negotiation method according to claim 2, wherein the time parameter comprises at least two of the following:
a start time, an end time, and a duration of the sleep cycle for the corresponding link.

4. The sleep-cycle negotiation method according to claim 2, wherein the first identification information comprises first link control information and link identifier information;
the first link control information indicates quantity information of the sleep-cycle information in the first information element, and the link identifier information indicates the corresponding link for each sleep-cycle information.

5. The sleep-cycle negotiation method according to claim 2, wherein the first identification information comprises link presence information, and the link presence information indicates whether the sleep-cycle information for the corresponding link is comprised in the first information element.

6. The sleep-cycle negotiation method according to claim 5, wherein the first identification information further comprises second link control information, and the second link control information indicates quantity information of the sleep-cycle information in the first information element.

7. The sleep-cycle negotiation method according to claim 1, wherein a sleep time indicated by the sleep-cycle information does not overlap with a Target Wake Time (TWT) Service Period (SP) for the link corresponding to the sleep-cycle information.

8. A sleep-cycle negotiation method, performed by a station (STA), the method comprising:
receiving a first frame, wherein the first frame comprises a first information element, the first information element comprises sleep-cycle information of a first access point (AP) for a first link and sleep-cycle information of a second AP for a second link, and the first AP and the second AP are affiliated to a same access point multi-link device (AP MLD).

9. The sleep-cycle negotiation method according to claim 8, wherein the first information element comprises first identification information and time parameter information;
the first identification information indicates a corresponding link for each sleep-cycle information;
the time parameter information comprises a time parameter of a sleep cycle for the corresponding link, the time parameter is determined based on a reference time and a time offset value for the corresponding link, and the reference time comprises a time of sending the first frame.

10. The sleep-cycle negotiation method according to claim 9, wherein the time parameter comprises at least two of the following:
a start time, an end time, and a duration of the sleep cycle for the corresponding link.

11. The sleep-cycle negotiation method according to claim 9, wherein the first identification information comprises first link control information and link identifier information;
the first link control information indicates quantity information of the sleep-cycle information in the first information element, and the link identifier information indicates the corresponding link for each sleep-cycle information.

12. The sleep-cycle negotiation method according to claim 9, wherein the first identification information comprises link presence information, and the link presence information indicates whether the sleep-cycle information for the corresponding link is comprised in the first information element.

13. The sleep-cycle negotiation method according to claim 12, wherein the first identification information further comprises second link control information, and the second link control information indicates quantity information of the sleep-cycle information in the first information element.

14. The sleep-cycle negotiation method according to claim 8, wherein a sleep time indicated by the sleep-cycle information does not overlap with a Target Wake Time (TWT) Service Period (SP) for the link corresponding to the sleep-cycle information.

15. The sleep-cycle negotiation method according to claim 8, further comprising:
receiving at least two sleep-cycle information corresponding to a same link; and
using the sleep-cycle information with the latest sending time as the sleep-cycle information for the link.

16-17. (canceled)

18. A first access point (AP), comprising a memory and a processor, wherein a computer program is stored on the memory and executable by the processor, and the processor is configured to:
determine a first frame, wherein the first frame comprises a first information element, the first information element comprises sleep-cycle information of the first AP for a first link and sleep-cycle information of a second AP for a second link, and the first AP and the second AP are affiliated to a same access point multi-link device (AP MLD); and
send the first frame.

19. A non-transitory computer-readable storage medium having a computer program stored thereon, which when executed by a processor, causes the method according to claim 1 to be implemented.

20. A station (STA), comprising a memory and a processor, wherein a computer program is stored on the memory and executable by the processor, and the processor is configured to execute the computer program to implement the method according to claim 8.

21. A non-transitory computer-readable storage medium having a computer program stored thereon, which when executed by a processor, causes the method according to claim 8 to be implemented.

22. The sleep-cycle negotiation method according to claim 1, wherein the first frame comprises a Beacon frame, a Probe Response frame, an Association Response frame, or a Reassociation Response frame.
